(19) United States
(12) Patent Application Publication
(10) Pub. No.: US 2022/0245849 A1
(43) Pub. Date: Aug. 4, 2022

(54) MACHINE LEARNING AN OBJECT DETECTION PROCESS USING A ROBOT-GUIDED CAMERA

(71) Applicant: KUKA Deutschland GmbH, Augsburg (DE)

(72) Inventors: Kirill Safronov, Augsburg (DE); Pierre Venet, Augsburg (DE)

(21) Appl. No.: 17/608,665

(22) PCT Filed: May 5, 2020
(86) PCT No.: PCT/EP2020/062358

§ 371 Date: Nov. 3, 2021

(30) Foreign Application Priority Data
May 6, 2019 (DE) 10 2019 206 444.2

(51) Int. Cl. G06T 7/70; G06V 10/12; G06V 10/774; G06V 10/82; H04N 5/232; G06V 10/70; G06T 17/00; B25J 9/16

(52) U.S. Cl. CPC G06T 7/70; G06V 10/12; G06V 10/774; G06V 10/82; H04N 5/23299; G06T 2210/56; G06T 17/00; B25J 9/1697; B25J 9/163; G06T 2207/20081; G06T 2207/20084; G06V 10/87

(57) ABSTRACT

A method for machine learning an object detection process using at least one robot-guided camera and at least one learning object includes positioning the camera in different positions relative to the learning object using a robot and capturing and storing at least one localization image, in particular a two-dimensional and/or three-dimensional localization image, of the learning object in each position. A virtual model of the learning object is ascertained on the basis of the positions and at least some of the localization images, and the position of a reference of the learning object in at least one training image captured by the camera, in particular at least one of the localization images and/or at least one image with at least one interference object which is not imaged in at least one of the localization images, is ascertained on the basis of the virtual model. An object detection of the reference on the basis of the ascertained position in the at least one training image is machine learned.

### CROSS-REFERENCE TO RELATED APPLICATIONS

This application is a national phase application under 35 U.S.C. § 371 of International Patent Application No. PCT/EP2020/062358, filed May 5, 2020 (pending), which claims the benefit of priority to German Patent Application No. DE 10 2019 206 444.2, filed May 6, 2019, the disclosures of which are incorporated by reference herein in their entirety.

### TECHNICAL FIELD

The present invention relates to a method and a system for machine learning an object detection process using at least one robot-guided camera and a learning object or for operating a robot using the learned object detection process, as well as a computer program product for carrying out the method.

### BACKGROUND

Using object detection processes, robots can advantageously interact more flexibly with their environment, for example, they can grip, process or the like objects which are positioned in a manner not known in advance.

Object detection processes can advantageously be machine learned. In particular, artificial neural networks can be trained to identify bounding boxes, masks or the like in captured images.

For this purpose, the corresponding bounding boxes have hitherto had to be marked manually in a large number of training images, in particular if different objects or object types are to be detected or handled robotically.

### SUMMARY

An object of one embodiment of the present invention is to improve machine learning of an object detection process. An object of a further embodiment of the present invention is to improve an operation of a robot.

These objects are achieved by a method, and by a system or computer program product for carrying out a method as described herein.

According to one embodiment of the present invention, a method for machine learning an object detection process using at least one robot-guided camera and at least one learning object has the step of:

positioning the camera in different positions relative to the learning object using a robot, wherein at least one localization image, in particular a two-dimensional and/or a three-dimensional localization image, which images the learning object, is captured in each position and is stored.

In this way, different localization images can advantageously be captured at least partially automatically, wherein the captured perspectives or positions of the images relative to one another are known and are (specifically) specified in one embodiment on the basis of the known positions of the camera-guiding robot or the correspondingly known positions of the robot-guided camera.

In one embodiment, a position describes a one-, two- or three-dimensional position and/or a one, two or three-dimensional orientation.

According to one embodiment of the present invention, the method has the steps of:

ascertaining a virtual model of the learning object on the basis of the positions and at least some of the localization images; and

ascertaining the position of a reference of the learning object in one or more training images captured by the camera, in one embodiment in one or more of the localization images and/or one or more images with one or more interference objects which are not imaged in at least one of said localization images, on the basis of the virtual model.

By ascertaining a virtual model of the learning object and using said model to ascertain a position of a reference of the learning object, said position can advantageously be at least partially automated and thus easily and/or reliably ascertained and then used for machine learning, in particular in the case of learning objects not known in advance.

According to one embodiment of the present invention, the method accordingly has the step of:

machine learning an object detection of the reference on the basis of the ascertained position(s) in the training image(s).

The reference can in particular be a simplified representation of the learning object, in one embodiment an in particular three-dimensional body, in particular a bounding body, in one embodiment a (bounding) polyhedron, in particular cuboid or the like, an in particular two-dimensional curve, in particular a bounding curve, in one embodiment a (bounding) polygon, in particular rectangular or the like, a mask of the learning object or the like.

In one embodiment, the robot has at least three, in particular at least six, in one embodiment at least seven, axes, in particular swivel joints.

In one embodiment, advantageous camera positions can be approached through at least three axes, advantageous camera positions through at least six axes, advantageously redundant through at least seven axes, so that, for example, obstacles can be avoided or the like.

In one embodiment, machine learning comprises training an artificial neural network, in one embodiment a deep artificial neural network, in particular a deep convolutional neural network or deep learning. This machine learning (method) is particularly suitable for the present invention. Correspondingly, the object detection process (machine learned or to be machine learned) comprises in one embodiment an artificial neural network (trained or to be trained) and can in particular be implemented as a result.

In one embodiment, ascertaining the virtual model comprises a reconstruction of a three-dimensional scene from localization images, in one embodiment by means of a method for visual simultaneous localization and mapping (“visual SLAM”).

As a result, in one embodiment, the virtual model can advantageously be ascertained, in particular simply and/or reliably, in the case of an unknown position and/or shape of the learning object.

Additionally or alternatively, ascertaining the virtual model comprises in one embodiment an at least partial elimination of an environment imaged in localization images.

As a result, in one embodiment, the virtual model can advantageously be ascertained, in particular simply and/or reliably, in the case of an unknown position and/or shape of the learning object.

Additionally or alternatively, the learning object is arranged in a known, in one embodiment empty, environment while the localization images are captured, in particular on an (empty) surface, in one embodiment of known color and/or position, for example a table or the like.

As a result, in one embodiment, the elimination of the environment can be improved, in particular it can be carried out (more) simply and/or (more) reliably.

Additionally or alternatively, ascertaining the virtual model in one embodiment comprises filtering, in one embodiment before and/or after the reconstruction of a three-dimensional scene and/or before and/or after the elimination of the environment.

As a result, the virtual model can be determined (more) advantageously, in particular (more) reliably, in one embodiment.

In one embodiment, ascertaining the virtual model comprises ascertaining a point cloud model. The virtual model can accordingly have, in particular be, a point cloud model.

As a result, in one embodiment, the virtual model can be ascertained particularly advantageously, in particular simply, flexibly and/or reliably, if the position and/or shape of the learning object is unknown.

Additionally or alternatively, ascertaining the virtual model in one embodiment comprises ascertaining a network model, in particular a polygon (network) model, in one embodiment on the basis of the point cloud model. The virtual model can accordingly have, in particular be, a (polygon) network model.

As a result, the (further) handling or use of the virtual model can be improved in one embodiment.

In one embodiment, ascertaining the position of the reference comprises transforming a three-dimensional reference to one or more two-dimensional references. In particular, the position of a three-dimensional mask or a three-dimensional (bounding) body in the reconstructed three-dimensional scene and the corresponding individual localization images can first be ascertained and then transformed, in particular imaged or mapped, to the corresponding position of a two-dimensional mask or a two-dimensional (bounding) curve.

In this way, the position of the two-dimensional reference can advantageously, in particular simply, be ascertained.

In one embodiment, ascertaining the position of the reference comprises transforming a three-dimensional virtual model to one or more two-dimensional virtual models. In particular, the position of the virtual model in the reconstructed three-dimensional scene and the corresponding individual localization images can first be ascertained and then the corresponding position of a two-dimensional mask or a two-dimensional (bounding) curve can be ascertained herein.

In this way, the position of the two-dimensional reference can advantageously, in particular reliably, be ascertained.

According to one embodiment of the present invention, a method for operating an, in particular the, robot has the following steps:

ascertaining a position of one or more references of an operating object using the object detection process which has been learned using a method or system described herein; and

operating, in particular controlling and/or monitoring, said robot on the basis of said position.

A (learned) object detection process according to the invention is used with particular advantage to operate a robot, wherein said robot in one embodiment is also used to position the camera in different positions. In a further embodiment, the camera-guiding robot and the robot that is operated on the basis of the position ascertained using object detection are different robots. In one embodiment, controlling a robot comprises path planning and/or online control, in particular regulation. In one embodiment, operating the robot comprises contacting, in particular gripping, and/or processing the operating object.

In one embodiment, at least one camera, in one embodiment guided by the operated robot or another robot, captures one or more detection images which (each) image the operating object, in one embodiment in different positions (relative to the operating object), at least one detection image in each case. The position of the reference(s) of the operating object is/are ascertained in one embodiment on the basis of said detection image(s).

As a result, in one embodiment, the robot can advantageously, in particular flexibly, interact with its environment, for example contact, in particular grip, process or the like objects which are positioned in a manner not known in advance.

In one embodiment, the (used) object detection process is selected on the basis of the operating object from a plurality of existing object detection processes which have been learned using a method described herein, in one embodiment each for an object type. In one embodiment, the coefficients of the respectively trained artificial neural network are stored for this purpose after the respective training and a neural network is parameterized with the coefficients stored for an operating object or its type on the basis of which the robot is to be operated, for example for an object or its type to be contacted, in particular to be gripped or processed.

In this way, in one embodiment, an in particular identically structured artificial neural network can be parameterized specifically for each operating object (type) and an object detection process specific to the operating object (type) can be selected from a plurality of machine-learned object detection processes specific to an object (type). As a result, in one embodiment, an object detection process used to operate the robot, and thereby the operation of the robot, can be improved.

In one embodiment, a one- or multi-dimensional environmental and/or camera parameter based on an environmental and/or camera parameter in machine learning is specified for the object detection process, in particular identical to the environmental or camera parameter in machine learning. The parameter can in particular include an exposure, a (camera) focus or the like. In one embodiment, the environmental and/or camera parameter of machine learning is stored together with the learned object detection process.

As a result, in one embodiment, an object detection process used to operate the robot, and thereby the operation of the robot, can be improved.

In one embodiment, ascertaining the position of a reference of the operating object comprises transforming one or more two-dimensional references to a three-dimensional reference. In one embodiment, the positions of two-dimensional references are ascertained in various detection images using an object detection process, and the position of a corresponding three-dimensional reference is ascertained therefrom. If, for example, the position of a two-dimensional bounding box is ascertained using object detection in three detection images which are perpendicular to one another (captured images), the position of a three-dimensional bounding box can be ascertained therefrom.

In one embodiment, a position of the operating object is ascertained on the basis of the position of the reference of the operating object, in one embodiment on the basis of a virtual model of the operating object. If, for example, a position of a three-dimensional bounding body has been ascertained, in one embodiment the virtual model of the operating object can then be aligned in this bounding body and the position of the operating object can also be ascertained in this way. Likewise, in one embodiment, the position of the operating object in the bounding body can be ascertained using (an), in particular three-dimensional, matching (method).

As a result, operating the robot, in particular contacting, in particular gripping, and/or processing the operating object can be improved, for example by ascertaining the position and orientation of suitable contact, in particular gripping or processing surfaces on the basis of the virtual model or the position of the operating object or the like.

In one embodiment, on the basis of the position of the reference of the operating object, in particular the position of the operating object (determined therefrom), one or more working positions of the robot, in particular one or more working positions of an end effector of the robot, are ascertained, in particular planned, in one embodiment on the basis of operating data specified for the operating object, in particular specified contact, in particular gripping or processing surfaces or the like. In one embodiment, a movement, in particular a path, of the robot for contacting, in particular gripping or processing the operating object is planned and/or carried out or traversed on the basis of the ascertained pose of the reference or the operating object and, in a further development, on the basis of the specified operating data, in particular contact, in particular gripping or processing surfaces.

According to one embodiment of the present invention, a system, in particular in terms of hardware and/or software, in particular in terms of programming, is configured to carry out a method described herein.

According to one embodiment of the present invention, a system has:

means for positioning the camera in different positions relative to the learning object using a robot, wherein at least one localization image, in particular a two-dimensional and/or a three-dimensional localization image, which images the learning object, is captured in each position and is stored;

means for ascertaining a virtual model of the learning object on the basis of the positions and at least some of the localization images;

means for ascertaining the position of a reference of the learning object in at least one training image captured by the camera, in particular at least one of the localization images and/or at least one image with at least one interference object which is not imaged in at least one of the localization images, on the basis of the virtual model; and

means for machine learning an object detection of the reference on the basis of the ascertained position in the at least one training image.

Additionally or alternatively, a system has:

means for ascertaining a position of at least one reference of an operating object using the object detection process which has been learned as described herein; and

means for operating the robot on the basis of said position.

In one embodiment, the system or its means has:

means for training an artificial neural network; and/or

means for reconstructing a three-dimensional scene from localization images; and/or

means for at least partially eliminating an environment imaged in localization images; and/or

means for filtering; and/or

means for ascertaining a point cloud model; and/or

means for ascertaining a network model; and/or

means for transforming a three-dimensional reference to at least one two-dimensional reference and/or a three-dimensional virtual model to at least one two-dimensional virtual model; and/or

means for capturing at least one detection image by means of at least one, in particular robot-operated, camera which images the operating object, and means for ascertaining the position on the basis of said detection image; and/or

means for selecting the object detection process on the basis of the operating object from a plurality of existing object detection processes which have been learned using a method described herein; and/or

means for specifying an environmental and/or camera parameter for the object detection process on the basis of an environmental and/or camera parameter in machine learning; and/or

means for transforming at least one two-dimensional reference to a three-dimensional reference; and/or

means for ascertaining a position of the operating object on the basis of the position of the reference of the operating object, in particular on the basis of a virtual model of the operating object; and/or

means for ascertaining at least one working position of the robot, in particular a working position of an end effector of the robot, on the basis of the position of the reference of the operating object, in particular the position of the operating object, in particular on the basis of operating data specified for the operating object.

A means within the meaning of the present invention may be designed in hardware and/or in software, and in particular may comprise a data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state and/or other non-volatile media. The program may be designed in such a way that it embodies or is capable of carrying out the methods described herein, so that the processing unit is able to carry out the steps of such methods and thus, in particular, is able to learn object detection or operate the robot. In one embodiment, a computer program product may comprise, in particular, a non-volatile storage medium for storing a program or comprise a program stored thereon, an execution of this program prompting a system or a controller, in particular a computer, to carry out the method described herein or one or multiple of steps thereof.

In one embodiment, one or multiple, in particular all, steps of the method are carried out completely or partially automatically, in particular by the system or its means.

In one embodiment, the system includes the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for machine learning an object detection process according to an embodiment of the present invention; and

FIG. 2 illustrates a method for machine learning according to an embodiment of the present invention.

### DETAILED DESCRIPTION

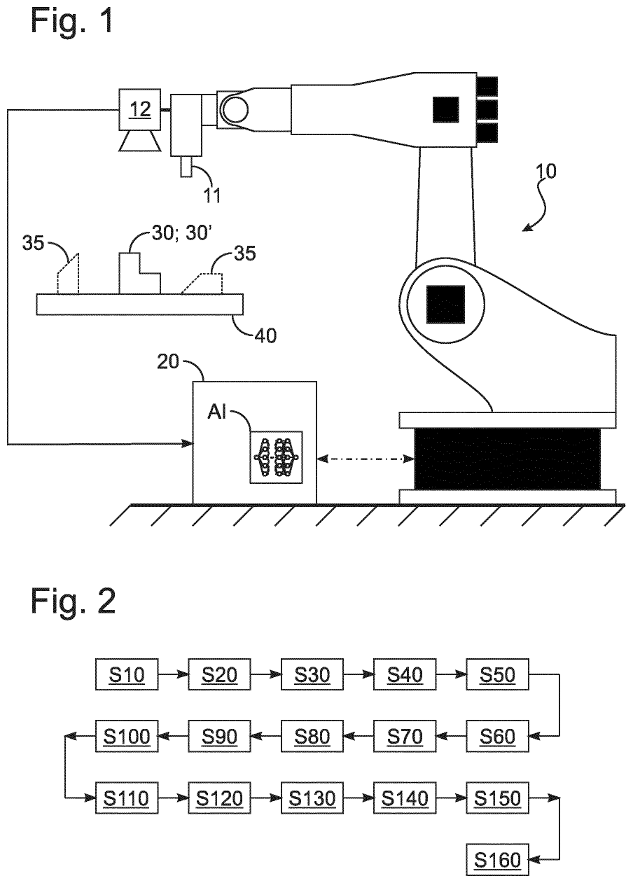

FIG. 1 shows a system according to an embodiment of the present invention with a robot 10, to the gripper 11 of which a (robot-guided) camera 12 is attached.

First, object detection of a reference of a learning object 30, which is arranged on a table 40, is machine learned using a robot controller 20.

For this purpose, in step S10 (cf. FIG. 2), the robot 10 positions the camera 12 in different positions relative to the learning object 30, wherein a two-dimensional and a three-dimensional localization image, which images the learning object 30, is captured in each position and is stored. FIG. 1 shows the robot-guided camera 12 by way of example in such a position.

Using a method for visual simultaneous localization and mapping, a three-dimensional scene with the learning object 30 and the table 40 is reconstructed (FIG. 2: step S20) from the three-dimensional localization images, from which an environment in the form of the table 40 is eliminated, in particular segmented out, in these localization images (FIG. 2: step S30).

After filtering out interfering signals (FIG. 2: step S40, wherein steps S30 and S40 can also be interchanged), a virtual point cloud model is ascertained therefrom (FIG. 2: step S50), from which, for example by means of a Poisson method, a virtual network model of polygons is ascertained (FIG. 2: step S60), which represents the learning object 30.

Now, in step S70, a three-dimensional reference of the learning object 30 in the form of a cuboid (“bounding box”) or another mask is ascertained and this is transformed in step S80 into the two-dimensional localization images from step S10. The position of the three-dimensional reference is ascertained in the respective three-dimensional localization image and the corresponding position of the corresponding two-dimensional reference is ascertained therefrom in the associated two-dimensional localization image captured by the camera 12 in the same position as said three-dimensional localization image.

Subsequently, in step S90, interference objects 35 are placed on the table 40 and further two-dimensional training images are then captured, which image both the learning object 30 and said interference objects 35 not imaged in the localization images from step S10. The camera 12 is preferably repositioned in positions in which it has already captured the localization images. The three-dimensional reference of the learning object 30 is also transformed into said further training images as described above.

Then, in step S100, an artificial neural network AI is trained to ascertain the two-dimensional reference of the learning object 30 in the two-dimensional training images which now each contain the learning object 30, its two-dimensional reference and, in some cases, additional interference objects 35.

The object detection process machine learned in this way or the neural network AI trained in this way can now ascertain the corresponding two-dimensional reference, in particular a bounding box or another mask, in two-dimensional images in which the learning object 30 or another object 30′ which is (sufficiently) similar, in particular of the same type, is imaged.

In order to now grip such operating objects 30′ with the gripper 11 of the robot 10 (or another robot (gripper)), in step S110 the corresponding object detection process, in particular the appropriate(ly trained) artificial neural network, is selected in one embodiment by parameterizing an artificial neural network AI with the corresponding parameters stored for the object detection of said operating objects.

In step S120, detection images which image the operating object are then captured by the camera 12 in different positions relative to the operating object, and the two-dimensional reference is ascertained in each of these detection images by means of the selected or parameterized neural network AI (FIG. 2: step S130) and by means of transformation, a three-dimensional reference of the operating object 30′ is ascertained therefrom in the form of a bounding box or another mask (FIG. 2: step S140).

On the basis (of the position) of this three-dimensional reference and operating data specific to an object type specified for the operating object 30′, for example a virtual model, specified gripping points or the like, a suitable gripping position of the gripper 11 is then ascertained in step S150, which the robot approaches in step S160 and grips the operating object 30′ (FIG. 2: step S170).

Although embodiments have been explained in the preceding description, it is noted that a large number of modifications are possible. It is also noted that the embodiments are merely examples that are not intended to restrict the scope of protection, the applications and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE SIGNS

10 Robot
11 Gripper
12 Camera
20 Robot controller
30 Learning object
30′ Operating object
35 Interference object
40 Table (environment)
AI Artificial neural network

What is claimed is:

1-9. (canceled)

10. A method for machine learning an object detection process using at least one robot-guided camera and at least one learning object, the method comprising:
positioning the camera in different predetermined positions relative to the learning object using a robot;
capturing and storing at least one localization image of the learning object in each position;
ascertaining with a robot controller a virtual model of the learning object based on the positions and at least some of the localization images;
ascertaining the position of a reference of the learning object in at least one training image captured by the camera based on the virtual model; and
machine learning an object detection of the reference on the basis of the ascertained position in the at least one training image.

11. The method of claim 10, wherein at least one of:
the at least one localization image of the learning object is a two-dimensional localization image or a three-dimensional localization image; or
the at least one training image is at least one of:
at least one of the localization images, or
at least one image with at least one interference object which is not imaged in at least one of the localization images.

12. The method of claim 10, wherein the robot has at least three axes.

13. The method of claim 12, wherein the at least three robot axes are swivel joints.

14. The method of claim 10, wherein machine learning comprises training an artificial neural network.

15. The method of claim 10, wherein ascertaining the virtual model comprises at least one of:
reconstructing a three-dimensional scene from the localization images;
at least partially eliminating an environment imaged in the localization images;
filtering;
ascertaining a point cloud model; or
ascertaining a network model.

16. The method of claim 10, wherein ascertaining the position of the reference comprises a transformation of at least one of:
a three-dimensional reference to at least one two-dimensional reference; or
a three-dimensional virtual model to at least one two-dimensional virtual model.

17. A method for operating a robot, comprising:
ascertaining with a robot controller a position of at least one reference of an operating object using an object detection process that has been learned according to claim 10; and
issuing commands to the robot for carrying out a task based on the ascertained position.

18. The method of claim 17, wherein at least one of:
the method further comprises capturing at least one detection image, which images the operating object, with at least one camera and ascertaining the position based on the captured detection image;
based on the operating object, the object detection process is selected from a plurality of existing object detection processes that have been learned;
the method further comprises specifying at least one of an environmental parameter or a camera parameter for the object detection process based on at least one of an environmental parameter or camera parameter in determined by or during machine learning;
ascertaining the position of at least one reference of the operating object comprises a transformation of at least one two-dimensional reference to a three-dimensional reference;
a position of the operating object is ascertained on the basis of the position of the reference of the operating object; or
the method further comprises ascertaining at least one working position of the robot based on the position of the reference of the operating object.

19. The method of claim 18, wherein at least one of:
the at least one camera capturing the at least one detection image is a robot-operated camera;
ascertaining the position of the operating object based on the position of the reference of the operating object comprises ascertaining the position of the operating object based on a virtual model of the operating object;
ascertaining the at least one working position of the robot based on the position of the reference comprises ascertaining based on the position of the operating object;
the at least one working position of the robot is a working position of an end effector of the robot; or
the at least one working position of the robot is ascertained based on operating data specified for the operating object.

20. A system for at least one of machine learning an object detection process or operating a robot, the system comprising at least one of:
a) means for positioning at least one robot-guided camera in different positions relative to at least one learning object using a robot,
means for capturing and storing in each position at least one localization image that images the learning object,
means for ascertaining a virtual model of the learning object based on the positions and at least some of the localization images,
means for ascertaining the position of a reference of the learning object in at least one training image captured by the camera based on the virtual model, and
means for machine learning an object detection of the reference based on the ascertained position in the at least one training image; or
b) means for ascertaining a position of at least one reference of an operating object using an object detection process that has been learned according to claim 1, and
means for operating the robot based on the ascertained position.

21. The system of claim 20, wherein at least one of:
the at least one localization image of the learning object is a two-dimensional localization image or a three-dimensional localization image; or
the at least one training image is at least one of:
at least one of the localization images, or
at least one image with at least one interference object which is not imaged in at least one of the localization images.

22. A computer program product for machine learning an object detection process using at least one robot-guided camera and at least one learning object, the computer program product including program code stored on a non-transient, computer-readable medium, the program code, when executed by a computer, causing the computer to:
position the camera in different predetermined positions relative to the learning object using a robot;
capture and store at least one localization image of the learning object in each position;
ascertain a virtual model of the learning object based on the positions and at least some of the localization images;
ascertain the position of a reference of the learning object in at least one training image captured by the camera based on the virtual model; and
machine learn an object detection of the reference on the basis of the ascertained position in the at least one training image.
